(19) United States
(12) Patent Application Publication
(10) Pub. No.: US 2011/0022461 A1
(43) Pub. Date: Jan. 27, 2011

(54) Privacy-safe targeted advertising method and system

(76) Inventor: Simeon S. Simeonov, Lincoln, MA (US)

Correspondence Address: LAW OFFICE OF DAVID H. JUDSON, 15950 DALLAS PARKWAY, SUITE 225, DALLAS, TX, 75248, US

(21) Appl. No.: 12/769,752

(22) Filed: Apr. 29, 2010

Related U.S. Application Data
(60) Provisional application No. 61/173,611, filed on Apr. 29, 2009.

(51) Int. Cl. G06Q 30/00

(52) U.S. Cl. 705/14.49

(57) ABSTRACT

A method and system for sophisticated consumer deep profile building provided as a service in a certifiably clean, i.e., privacy-safe, manner to advertisers, ad networks, publishers, aggregators and service providers. In an embodiment, an entity provides a tracking and targeting service that acts as a container for sensitive consumer information. The entity preferably implements a stringent policy of transparency and disclosure, deploys sophisticated security and data anonymization technologies, and it offers a simple, centralized consumer service for privacy disclosure, review and deletion of collected profile information, opt-in, opt-out, and the like. In exchange, advertisers, ad networks, publishers, aggregators and service providers (including, without limitation, mobile operators, multiple service providers (MSPs), Internet service providers (ISPs), and the like), receive privacy-safe targeting services without ever having to touch sensitive information.

This application is based on and claims priority to Ser. No. 61/173,611, filed Apr. 29, 2010.

### BACKGROUND OF THE INVENTION

1. Technical Field

This disclosure relates generally to providing targeted advertising to users of computing devices, including mobile phones, in a privacy-secure manner.

2. Background of the Related Art

Consumers are enjoying an unprecedented personal relationship with computing devices, from PCs to mobile devices such as the iPhone®. Moreover, the technologies for targeting and tracking of consumers are getting more sophisticated, and the advertising value chain across all channels is getting longer and more complex. Of course, as data collecting grows, privacy erodes. Advertisers want to reach a highly-targeted audience at scale. Effective targeting outside of search, however, typically involves tracking consumer behavior. This type of tracking, also known as behavioral advertising or behavioral targeting, often is used in combination with targeting based on contextual, demographic and other data collected from a variety of online and offline data sources.

Consumer tracking and deep profile building, the core of effective targeting, have serious privacy implications.

### BRIEF SUMMARY

A method and system for sophisticated consumer deep profile building, viewer and advertising context certification, targeting and reporting, which is provided as a service in a certifiably clean, i.e., privacy-safe, manner to advertising ecosystem participants such as advertisers, ad networks, ad exchanges, publishers, aggregators and service providers. In an embodiment, an entity provides a tracking and targeting service that acts as a container for sensitive consumer informationincluding, but not limited to, personally identifiable information (PII). The entity preferably implements a stringent policy of transparency and disclosure, deploys sophisticated security and data anonymization technologies, and offers a simple, centralized consumer service for privacy disclosure, review and deletion of collected profile information, opt-in, opt-out, and the like. In exchange, advertisers, ad networks, publishers, aggregators and service providers (including, without limitation, mobile operators, multiple service providers (MSPs), Internet service providers (ISPs), and the like), receive privacy-safe targeting services without ever having to touch sensitive information.

To this end, an entity such as described above uses a synthetic construct, referred to herein as an audience certification assertion (ACA) or audience query tag (AQT), which is designed to be independent of any given request for an ad and any given consumer profile. In particular, a given ACA is designed to encapsulate a request or query for certain contextual, behavioral, social and/or demographic information into an opaque, effectively impenetrable token. In this manner, substantially all of the privacy risk associated with such information is concentrated in the entity that creates and manages the ACA tokens. Advertisers create campaigns using the tokens, and ad serving technologies use the tokens to determine which ads to serve in response to given ad requests. The token certifies that the ad that is about to be displayed satisfies the targeting criteria associated with the request, and that the request has been satisfied in a privacy-safe manner.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an extensible architecture in which exemplary aspects of the illustrative embodiments may be implemented;

FIG. 2 is an exemplary block diagram of an implementation of a set of advertising system components for implementing privacy-safe ad targeting according to this disclosure;

FIG. 3 is a process flow diagram illustrating an exemplary interaction to provide privacy-safe ad targeting;

FIG. 4 is a sample process workflow for specifying and using AQTs;

FIG. 5 is a sample algorithm for selecting an advertisement according to a first representative embodiment; and

FIG. 6 is a sample algorithm for selecting an advertisement according to a second representative embodiment.

### DETAILED DESCRIPTION OF AN ILLUSTRATIVE EMBODIMENT

The reader is assumed to be familiar with the known technologies and business models associated with Internet-based advertising systems and technologies.

FIG. 1 illustrates a high level view of an extensible architecture 100 for use in implementing the subject invention. As described above, an entity provides privacy-safe ad targeting services. This Entity 102 is shown below as “NewCo.” Preferably, the Entity is an independent service provider, but this is not a limitation. The Entity may be integrated (in a secure manner) within an advertiser exchange, an advertising network, or the like. The Entity receives and stores events 104 from one or more data partners 106, applies appropriate analytics (behavioral, contextual, demographic, social, location, etc.) 108, and generates and stores profiles 110. A representative profile is shown on the right-hand portion of the drawing and comprises an entity ID 112, a set of one or more partner identifiers 114, the profile information 116, an opt-in status (by partner) 118, and a set of one or more audience certification assertions/query tags 120. This profile, however, is not meant to be limiting, as a “profile” is any logical data structure whose physical representation may be distributed across multiple systems. A common example is that of “opt-in” or “opt-out” status in Web advertising. For performance and privacy reasons, the whole or parts of profile information sometimes may be stored and/or cached in one or more cookies or Flash shared objects (FSOs) across one or more domains. Generalizing, profile information thus distributed (sometimes to third party systems) can be linked together via one or more correlation mechanisms, e.g., browser session state, proxies, correlation identifiers, and the like. As will be described, the techniques described herein enable the management of sensitive information in one place (preferably by a single entity), even though one or more pieces or copies of the sensitive data may reside in physically distinct locations.

The audience certification assertions/query tags 120 are sometimes referred to as “tokens.” As described herein, tokens are described by one or more acronyms: ACA, ACT, AQT, etc., which are not meant to be limiting. The Entity 102 may have one or more partners who each collect similar type of information. A “visit graph” 122 as identified in the drawing is a theoretical data structure that shows which person/device consumed/visited which page/site/content. The events collected by the Entity are useful to generate a visit graph. According to the teachings herein, this visit graph may then be merged with some other (disjoint) visit graph, e.g., a graph generated by an Entity Partner. By merging disjoint visit graphs in this manner, either the Entity or the Partner (as the case may be) can infer certain additional information of the persons for which the other party is collecting events, for example, demographics information. The visit graph is illustrative, as it can be any other data structure.

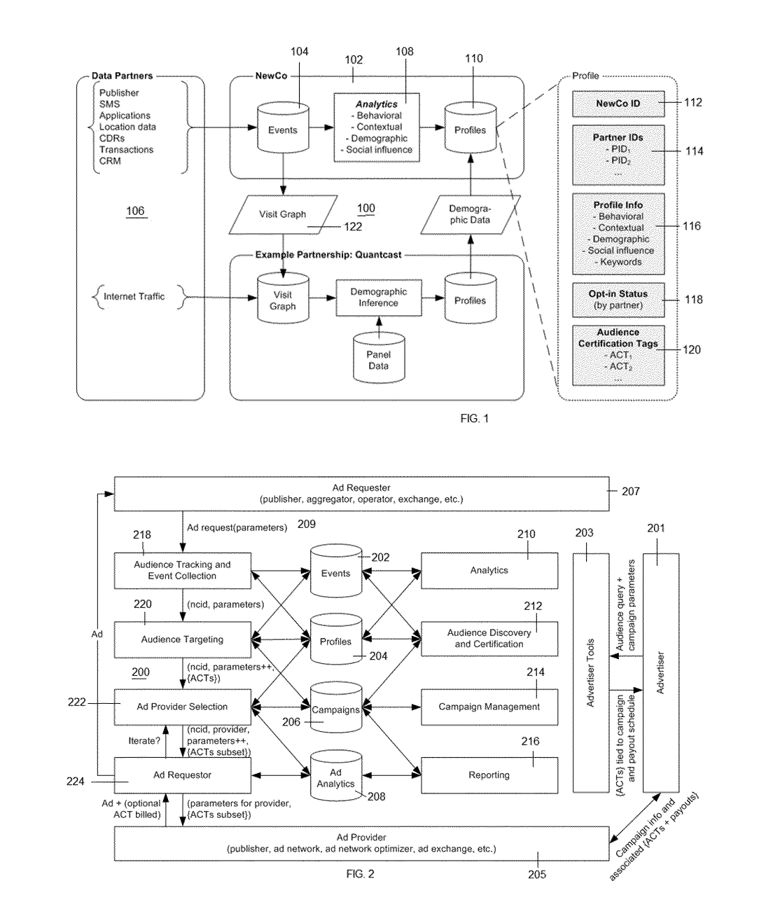

FIG. 2 represents a detailed implementation of the Entity (NewCo) 200, which is located within the dotted line. The Entity 200 preferably comprises several databases, a number of back-end functional modules, a number of integration/API modules for engaging with third party services, and a number of front-end ad functional modules that provide an ad distribution/selection capability as will be described. In the illustrated embodiment, the databases include, for example, an Events database 202, a Profiles database 204, a Campaigns database 206, and Ad Analytics database 208. The back-end functional modules include, for example, an Analytics module 210, an Audience Discovery and Certification module 212, a Campaign Management module 214, and a Reporting module 216. As noted above, a profile is a logical construct; thus, some profile information may only be available at runtime and not always stored in one place (such as database 204) or stored at all, e.g., when it comes from protocol state such as an IP address or when dynamically resolved such as geo-location information generated based on an IP address. The front-end functional modules include, for example, an Audience Tracking and Event collection module 218, an Audience Targeting module 220, an Ad Provider Selection module 222, and an Ad Requestor module 224. The front-end and back-end modules interact with the databases in the manner shown by the arrows. Of course, one of ordinary skill in the art will appreciate that the individual databases may be combined in any convenient manner, including via batch-mode and protocol or API-driven connections to other data and services, including those that become available as a result of the processing of requests, e.g., those related to the HTTP protocol Likewise, the various front-end and back-end functional modules may be combined or managed in any convenient manner. One or more of these functional modules may be located remotely or carried out in a distributed manner by NewCo, or third parties with which NewCo is working. In other words, any of the above functions may be integrated with third parties that provide the particular function as a hosted or managed service.

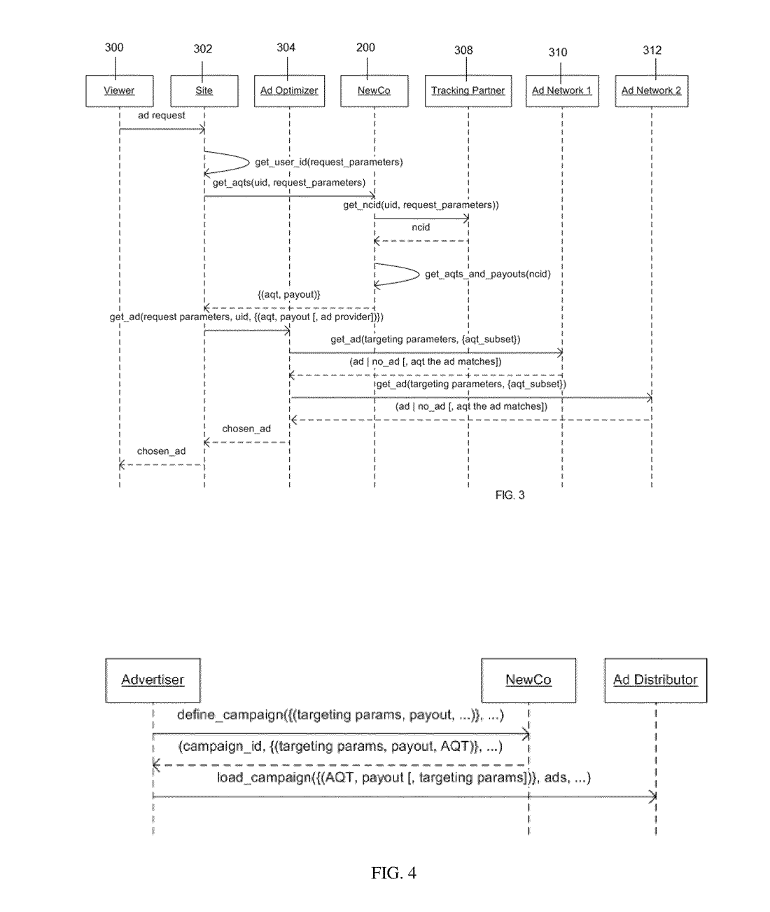

By way of background, an Advertiser 201 sets up a campaign using an Advertiser Tool 203 exposed by (or otherwise accessible from) the Entity. FIG. 4 illustrates a representative process flow for this setup process. During this process, the Advertiser 201 defines the campaign by its associated targeting parameters, (optionally) proposed payout(s), and the like. The Entity 200 returns a campaign identifier, together with one or more audience certification tokens as described above. With that information, the Advertiser 201 can then load the campaign to an Ad Distribution function as will now be described. To ensure privacy safety, the Entity may prevent or restrict the generation of tokens based on targeting parameters that result in very small audiences.

Preferably, a given campaign has associated therewith information such as the following:

_campaign ({(AQT, payout [targeting parameters])}, ads, . . . )

The campaign information and associated data (AQTs and optional payouts or payout minimums) are provided to an Ad Provider 205, which may be a publisher, ad network, ad network optimizer, ad exchange, or the like. In operation, an Ad Requester 207, such as a publisher, aggregator, operator, exchange, or the like, makes an Ad request 209 with one or more targeting parameters. The Ad request 209 is received at the Audience Tracking and Event Collection module 218. The Audience Tracking and Event Collection module 218 outputs a unique user ID within the Entity's domain (ncid), which does not need to be globally unique but simply unique in the context of a logical group of profiles that must be identified separately for the purposes or any specific request, together with the Ad request parameters, to the Audience Targeting module 220, which then outputs the ncid, parameters and ACTs to the Ad Provider Selection module 222. A user ID need not actually identify a person, although it may do so; it is a profile identifier that resolves to zero or more profiles. The Ad Provider Selection module 222 then passes a subset of the ACTs to the Ad Requestor module 224. Although in this embodiment NewCo uses the ID from a tracking partner as its profile identifier, this is not a requirement, as the tracking service, if one is used at all, may respond with information that NewCo then uses to identify (or create) an ncid.

An example of a process flow for the privacy safe ad targeting operation is seen by examining FIG. 2, together with the transaction flow shown in FIG. 3. In FIG. 3, a Viewer 300 makes the Ad request to a provisioned Site 302, whose software in turn interacts with an Ad Optimizer 304 and the various other entities, including NewCo 200, Tracking Partner 308, Ad Network 1 310 and Ad Network 2 312 directly or via passing control over to third parties, e.g., via a client- or server-side redirect as is common for online advertising over HTTP.

Note that FIG. 2 is a specific example that uses an ad network optimization provider but that this is not a requirement. As seen in FIG. 3, the Entity 200 (as shown in FIG. 2) receives a request from the Site 302 (or other Ad Requestor) following receipt of the ad request from the Viewer 300. The request received at the Entity is for the AQT tokens associated with a user id (uid) and a set of one or more request parameters. (In the alternative, the user id can be provided contextually via a browser/HTTP context, such as a cookie identifying the user, and that is made available to NewCo as part of the interaction). In response, the Entity obtains or generates AQTs and optional payouts associated with the user. In one embodiment, this is done by first converting a user id (uid) to a unique user id within the Entity's domain (ncid), which may occur using one or more third party tracking and identity correlation services. The Entity then returns to the Site an appropriate response. The Site then makes a request for an ad to the Ad Optimizer, passing the request parameters, and the uid, where the uid has associated therewith the AQT, and payout information, if any, for one or more Ad Networks that may be able to supply the conforming ad. The Ad Optimizer (in this embodiment, where one is used) then makes one or more ad requests to the Ad Networks, passing the targeting parameters and AQT. The Ad Networks may be called serially or in parallel. In a common variation, multiple networks or exchanges can be “chained” together via client- or server-side redirects, allowing for the possibility that they could act as ad requestors and may use the services of NewCo in separate and distinct interaction flows. The Ad Networks provide their responses, which are then processed as necessary by the Ad Optimizer to select an ad, which is then returned to the Site, and then to the Viewer. In another variation, in the case where multiple ad providers are called in serial or in parallel through APIs that do not allow for an ad inventory check without an associated billable event but only for ad requests where an ad is always delivered and this creates a billable event, NewCo can choose one of the ads to return and “store” the other for future delivery to make good on the billable event. In these cases, NewCo operates its own version of a small ad provider with a set of cached ad responses from other ad providers received previously in this manner. The particular implementation is managed by software informed by the contracts and terms of service of the ad requester and providers involved.

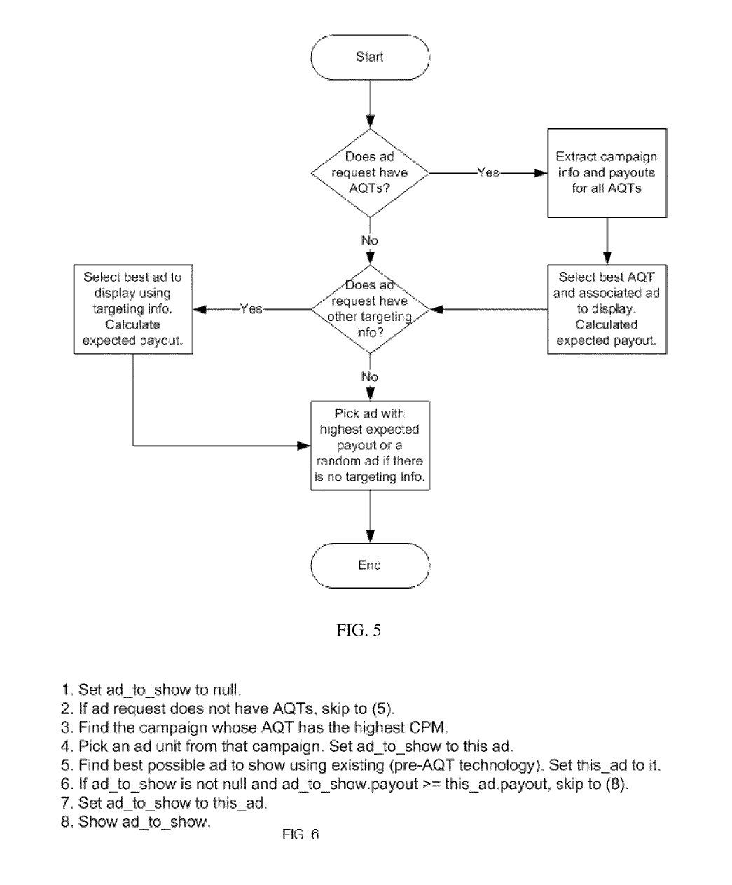

FIG. 5 is one possible process workflow for an Ad Provider (e.g., an Ad Network shown in FIG. 3). In this example, a test is performed to determine if an ad request has AQTs associated therewith. If so, the campaign information and payouts are extracted for all AQTs that came with the ad request. A best AQT and associated ad to display is then selected, and an expected payout is calculated. A test is then performed to determine whether the ad request has any other targeting information associated therewith. (As shown, this test is reached if the ad request does not have AQTs). If so, the Ad Provider selects the best ad to display using the other targeting information, and an expected payout is calculated. An ad with the highest expected payout (or a random ad is there is no targeting information) is then selected and returned. (As shown, this last step is reached if the ad request does not have other targeting information.) Note that choosing the ad with the highest expected payout may involve choosing to make a redirect to another network or exchange and let it handle the ad request, as is common, for example, in the online advertising industry. Therefore, the mechanism by which NewCo makes ad requests to ad providers preferably is domain-specific and protocol-specific to allow for this possibility. Further, note that in the case of optional payout information, the ad provider can still use AQTs in addition to any traditional targeting info to calculate expected payouts and optimize ad selection. This is particularly desirable in the context of ad targeting through real-time exchanges where passed in AQTs can allow multiple parties to make their own decisions regarding how much an ad is worth based on the AQTs and bid appropriately for the opportunity to deliver an ad for the ad request.

FIG. 6 identifies a representative alternative algorithm for CPM campaigns. The techniques disclosed herein are not limited to any particular type of campaign; thus, as used herein “campaign” should be broadly construed to refer to known techniques and processes such as, without limitation, CPM, CPC, CPA, sponsorships and the like. The particular payout values will vary depending on the type of campaign. It should also be noted that the techniques disclosed herein are not limited to any particular type of advertising form or medium (TV/iTV/VOD/cable, Web/WAP, video, applications, SMS, instant messaging, etc.)

The following provides additional details regarding an embodiment of the disclosed system and method. There are preferably several phases, including a campaign setup phase, a preparation phase, and an execution/reporting phase. Of course, this description is not to be taken by way of limitation.

During the campaign setup phase, the system collects and abstracts a set of campaign targeting criteria using opaque tokens such that a campaign has one or more targeting criteria subsets associated with additional information, such as payouts, frequency caps, and the like, that is matched with one or more corresponding tokens. The tokens are referred to herein as an audience certification assertion (ACA) or an audience query tag (AQT). The system ensures that the matching is persisted for efficient and flexible future querying and access (as described below during the execution phase). In addition, during the campaign setup phase, a mechanism is provided by which advertisers can associate one or more tokens and associated additional information (such as payouts) with new or existing campaigns pushed through one or more ad providers (e.g., publishers, ad networks, ad exchanges and the like). Preferably, the system aggregates and persists (or caches) this data for future querying or access.

NewCo, advertisers, ad distributors and other parties may choose to make AQTs known to other parties even outside the context of specific campaigns for the purposes of improving ad selection. For example, NewCo could publish average payouts associated with certain AQTs broadly to help the advertising ecosystem better determine what to do when they see an AQT present.

During the preparation (or pre-processing) phase, the system provides a mechanism by which a potentially large volume of stored, buffered or real-time information (e.g., events, consumer profiles, or any digital assets such as web pages, SMS marketing campaigns templates, videos, etc.) is analyzed to determine whether or how closely they match campaign targeting criteria and, therefore, certain ACAs. In addition, the system may pre-compute and store these matches in a form for efficient further processing or evaluation on an as-needed basis either precisely or using “close” matching (via heuristics, statistical or Bayesian inference, soft AI techniques (neural networks, genetic or evolutionary computation, fuzzy logic or variations, etc.) and the like).

During the execution phase, the system provides a mechanism by which zero or more ACAs are associated with a “request” (e.g., a page request, ad request, SMS message, video play, or the like) based on zero or more parameters associated with the ad request. These zero or more ACAs constitute a complete set (or some given subset) of ACAs whose campaign targeting criteria may be satisfied by the request. The set or given subset of ACAs that are associated with the request may be calculated using close matching techniques as described above, and optionally taking into consideration additional information, such as, without limitation, historical matches, historical fill rates and payouts, ACA payouts, campaign availability, ad inventory, impression availability within campaigns, and the like. The set or given subset of ACAs typically have associated additional information (metadata) such as expected payout likelihood, identifiers for the ad providers that support the tokens, etc. Preferably, the set or given subset of ACAs are sorted or rank-ordered in one or more ways including, without limitation, using information about available ad providers.

While the AQT token can be completely opaque, it is not a requirement. As noted, meta-data visible to all or just certain parties of the advertising ecosystem may be associated with an AQT, and additional meta-data can be sent along with an AQT as part of an interaction. Such meta-data may represent information or assertions about the AQT that are helpful in making targeting decisions or performing other processes, such as reporting, billing, and the like. Some of the meta-data may be independent from the user and interaction, while other meta-data can be user or interaction-specific. For example, an AQT may be associated with information about the advertiser, with payout information, with frequency of exposure to certain ads or campaigns (so that advertiser's rules on exposure frequency can be observed on a user-by-user basis), with additional information about the context of the ad request(e.g., on a page with adult or other type of objectionable content or on a page that is showing or not showing industry-standard notice with regards to online behavioral advertising (OBA) or other seals such as a TRUSTe seal), with opt-in or opt-out information about the user with respect to particular ad networks, ad exchanges and targeting services as a way to enhance targeting (which help with optimizing the redirect chain for ad targeting and ad serving), and so forth. The meta-data may come from third parties. In some cases, the meta-data will be transferred together with the AQT during interactions and in other cases it can be resolved via the AQT by querying services in batch mode or during interactions.

Also, AQTs do not have to be unique for each advertiser/campaign. To the extent that the privacy-safe nature of targeting via AQTs is not undermined, embodiments may selectively choose to use the same AQTs across certain advertisers and campaigns. AQTs can also be defined by parties other than advertisers. For example, they could be defined by an entity for the purposes of creating a marker describing a certain set of criteria, such as the case of a web publisher wanting to identify all visitors to its travel section. AQTs used in this manner are likely to have some public meta-data enabling others in the advertising ecosystem to make decisions on how to perform profile building, ad targeting and selection based on the availability of these AQTs.

Although not required, the system may provide for ad optimization during the execution phase. In particular, to facilitate ad selection, one or more ad providers are selected out of a pool of available ad providers based on ACAs associated with the ad request. The selection may be based, for example, on a sort or rank-ordering that, in turn, is based on a set of desired criteria, such as magnitude or expected payout, likelihood of ad fulfillment, and the like. A complete set or some subset of the ACAs associated with the request (e.g., ACAs that are known to be acceptable to the ad provider, the top five ACAs, etc.) is then passed to the selected ad provider(s) with an ad request. The ad provider then uses one or more ACAs from the request to determine which ad to serve. As one of ordinary skill will appreciate, because of the added targeting inherent in the described process, the ad provider may account for having served such an “ACA-certified” ad, and it may charge the advertiser a premium for delivery of such an ad (as per the payout specified by the advertiser for the particular ACA or as per some other agreement with the advertiser). The ad provider may then communicate back or report on which ACAs, if any, apply to the delivered ad and which ACA, if any, was chosen to account/bill the delivered ad.

More generally, the system provides a mechanism by which advertisers can receive aggregated or other reports showing ACA-certified ad impressions, clicks, and the like, as well as the associated payouts/costs. This reporting may be done by ad providers and by the Entity. The Entity may also provide an independent set of reports to advertisers and publishers to enable them to verify ad provider-supplied reports.

The audience certification token may be used with any type of advertising campaign, whether Internet-based, mobile-based, or the like.

The audience certification token obviates tracking or information sharing about an individual by parties and technologies external to the Entity. Rather, all (or substantially all) profile data resides within the Entity and is only exposed (in the form of the token) in a privacy-safe and secure manner. Tokens may be encrypted, or they may be communicated using known transport layer transport layer security mechanisms, such as HTTP over TLS (Transport Layer Security). Preferably, there is no information about a person (including, without limitation, any personally identifiable information (PII), which leaves the Entity. In this way, the ACA serves to abstract an audience query to preserve privacy. A further advantage of this architecture is that the Entity can ensure that ad providers do not track persons without authorization.

In one embodiment of this invention, advertisers may know the targeting criteria that are associated with an AQT and thus attempt to break the privacy-safe nature of targeting. This may occur in the case where a user interacts with an advertiser-associated system (e.g., when the user clicks an ad and eventually ends up on an advertiser landing page, by which the advertiser can then see or a priori know the AQT and can further track the user, say, through HTTP cookies. This problem can be addressing by fuzzing of AQT sets, associating multiple AQTs with different targeting parameters with a single ad URL, hosting of landing pages, and randomized monitoring of tracking attempts by advertisers.

The interaction diagrams and related text are merely exemplary. As one of ordinary skill in the art will appreciate, the various parts of the system can be used together or independently in many different interactions with other logical services that may or may not be operated by the NewCo entity or its partners.

Moreover, the various interactions and data flows shown in FIG. 2 and FIG. 3 also are merely representative, and they should not be taken to limit the disclosure. Thus, for example, the ad request may simply be a targeting request, such as “provide the ACAs associated with a particular context,” where the context is a correlation identifier, a browser request, a browser session, and so forth. The figures (and related text) describe publisher-initiated interactions and common types of client-side ad network-initiated interactions, but these approaches are merely representative. The techniques may be exchange-initiated, or implemented using redirects (client or server side). As noted, pieces of sensitive information may physically live in separate physical locations but work together through the various mechanisms, however implemented. The data collection/insertion from partners can happen at any time, namely, offline, online in real-time or not.

As used herein, the concept of “ad selection” should also be broadly construed. It may mean one of several things for any given entity receiving the tokens and any meta-data: finding ad(s) from the ads they have at their disposal, deciding not to select/deliver an ad (negative targeting), deciding to forward an option to select an ad to a third party with or without passing some/all tokens and some/all meta-data as well as any additional information (e.g., by way of a redirect, putting targeting information on the “floor” if the entity is an exchange to see who bids and how much, etc.), deciding to take some/all information passed in and use it to inform future targeting, and so forth. This latter case is the case of token usage for data collection and profile enhancement, e.g., associate an AQT with a profile, if this is allowed by the terms of service, as opposed to token usage for ad selection (on the spot). In addition, ads can be identified or delivered in many ways, e.g., directly, by ID, via a link, via an embeddable object, and so on.

There are many request-response interactions that may be implemented to facilitate privacy-safe ad targeting as contemplated herein. At a high level, an initiating interaction is a request for an ad and hence the goal is to delivery an ad (or a redirect or a snippet of code that eventually results in an ad), and there may be one or many “requests” within this process that include tokens. Tokens may or may not be “returned” in direct response to a particular request during an interaction. A particular request may be a request for tokens and meta-data as opposed to a request for an ad. A response to an initiating request may involve a separate request that is made with tokens and meta-data and a response to the separate request (or any series of indirections/redirects associated with it) is used to generate the response to the initiating request. A particular response to a request may be a set of zero or more data tokens, each of which is associated with zero or more items of meta-data. A particular request may be one that contains data that constitute identifier(s) used as parameter(s) in retrieving the set of data tokens and associated meta-data. These identifiers may identify one of the following: (a) a device, (b) a running software program, (c) a person (including legal entities that are considered persons), (d) a data structure linked to only one or more people as described in (c), (e) a uniform resource identifier (URI), (f) a data structure inside the entity, or (g) a data token. A response may involve generating one or more new data structures based on a request, data tokens and associated meta-data. A data structure may include a subset of the data tokens with associated subsets of their associated meta-data. A data structure may be contained in a response to a request, or the response may contain a mechanism for generating the data structure. The response could be code that generates/retrieves the data structure or it can be data (such as a link) that other software uses to retrieve the data structure. The data structure may contain meta-data about data tokens. The data structure may describe one or more ads or information that may be used to identify and perhaps retrieve and display one or more ads. The data structure may contain zero or more data tokens and additional information used to generate one or more requests to advertising-related services. The requests to advertising-related service(s) may have a subset of the data tokens with subsets of associated meta-data as parameters (in addition to other information) or provide information allowing such subsets to be obtained (e.g., by additional calls) by the service(s) or a combination of both. Responses from advertising-related services(s) may contain a data structure that describes one or more ads or information that may be used to identify and perhaps retrieve and display one or more ads.

The term “audience” as used herein should be broadly construed. As described, it means the parameters describing consumers (people) including, but not limited to, demographic, psychographic, social graph and behaviorial data, as well as explicitly or implicitly defined consumer preferences, such as opt-in vs. opt-out or advertiser/topic preference. In the context of the techniques disclosed herein, advertising-related information is collected and/or used, including but not limited to device and protocol information, geo-location information, surrounding content, and advertising targeting and delivery context, including but not limited to information about an advertising interaction and the parties and data sources contributing to it. For example, audience could be defined to match any subset of the following criteria: 18-24 year-old male Hispanics with high social influence currently in the New York City metro area who are interested in social gaming and who have not opted out of receiving ads from Google in the context of high-quality non-user-generated content on the topic of social gaming on a TRUSTe-certified website where all parties involved in the advertising interaction certify that they, and third parties whose data and services they are using, are following the advertising industry self-regulation guidelines for collecting and using online behavioral data and providing industry-standard notice of such to consumers.

The term “profile” as used herein means a collection of information related to an audience, from a single individual or device to groups and populations of such.

The term “campaign” as used herein describes a set of ads, the audience targeted by the ads, and any additional information such as payouts, etc. It includes the cases of real-time ad targeting or dynamic optimization where sometimes the association between ads and audience may be fleeting or evolving.

In one embodiment, the subject disclosure enables targeting advertising to mobile device users, although this is not a limitation. As used herein, a “mobile device user” should be broadly construed. It includes any wireless client device, e.g., a cellphone, pager, a personal digital assistant (PDA, e.g., with GPRS NIC), a mobile computer with a smartphone client, or the like. A typical mobile device is a wireless access protocol (WAP)-enabled or other similar device (e.g., an iPhone®, iPad, a Blackberry® device, or the like) that is capable of sending and receiving data in a wireless manner using the wireless or similar application protocol. The wireless application protocol (“WAP”) allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP- (or similar) enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats.

Wireless device operating environments in which the subject matter may be implemented also are well-known. In a representative embodiment, a mobile device is connectable (typically via WAP) to a transmission functionality that varies depending on implementation. Thus, for example, where the wireless device operating environment is a wide area wireless network (e.g., a 2.5 G network, a 3G network, a 3GS network, a 4G network, or the like), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the subject matter herein may be implemented in other (e.g., 3G) and next-generation mobile networks and devices as well. The mobile device is the physical equipment used by the end user, typically a subscriber to the wireless network. Typically, a mobile device is a 2.5 G- or 3G-(or higher) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like).

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the subject disclosure has been described in the context of a method or process, the present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A given implementation of the present invention is software written in a given programming language that runs on a web server (e.g., Apache) on a standard Intel hardware platform running an operating system such as Linux.

The invention may be practiced, typically in software, on one or more machines. Generalizing, a machine typically comprises commodity hardware and software, storage (e.g., disks, disk arrays, and the like) and memory (RAM, ROM, and the like). The particular machines used in the system are not a limitation of the present invention. A given machine includes network interfaces and software to connect the machine to a network in the usual manner. As described above, the subject matter may be implemented as a standalone product, or as a managed service (e.g., in an ASP model) using a set of machines, which are connected or connectable to one or more networks. More generally, the product or service is provided using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP), and a set of applications or processes (e.g., AJAX technologies, Java applets or servlets, linkable libraries, native code, or the like, depending on platform), that provide the functionality of a given system or subsystem. As described, the product or service may be implemented in a standalone server, or across a distributed set of machines. Typically, a server connects to the publicly-routable Internet, a corporate intranet, a private network, or any combination thereof, depending on the desired implementation environment.

While given components of the system have been described separately, one of ordinary skill will appreciate that some of the functions may be combined or shared in given instructions, program sequences, code portions, and the like.

While the subject matter herein has been described in the context of “advertising,” the term “advertising” should be broadly construed and extends to non-standard forms, such as cross-site product recommendation and the like.

In addition, a “targeting” operation need not necessarily involve an actual ad delivery.

Having described my invention, what I now claim is as follows.

1. Apparatus, comprising:
a processor;
a computer memory holding computer program instructions that when executed by the processor enable an entity to provide a method of privacy-safe ad targeting, the method comprising:
encapsulating into one or more opaque data tokens given contextual, behavioral, location, demographic or other information; and
using the data tokens to facilitate ad delivery.

2. The apparatus as described in claim 1 wherein the given contextual, behavioral, location, demographic or other information is associated with targeting criteria of one or more ad campaigns.

3. The apparatus as described in claim 1 wherein the using step facilitates data collection for future ad delivery.
